(19) United States
(12) Patent Application Publication
(10) Pub. No.: US 2019/0239527 A1
(43) Pub. Date: Aug. 8, 2019

(54) METHOD OF PRODUCING A FORTIFIED DAIRY PRODUCT

(71) Applicant: UNITED ARAB EMIRATES UNIVERSITY, Al Ain (AE)

(72) Inventors: SAMI GHNIMI, INCHEON (KR); ISMAIL ABDULHALIM, AL-AIN (AE); KLAITHEM SUBAIH SALEM AL KAABI, AL-AIN (AE)

(21) Appl. No.: 15/891,303

(22) Filed: Feb. 7, 2018

(51) Int. Cl. A23C 9/156; A23C 9/16; A23C 1/04; A23C 1/12; A23L 2/08

(52) U.S. Cl. CPC A23C 9/156; A23C 9/16; A23V 2002/00; A23C 1/12; A23L 2/08; A23C 1/045

(57) ABSTRACT

A method of making a fortified dairy product includes concentrating an amount of fruit juice and an amount of camel milk to obtain an amount of concentrated camel milk and an amount of concentrated fruit juice. The concentrated camel milk and the concentrated fruit juice can be heated and blended to produce a mixture. The mixture can then be spray dried to produce the fortified dairy product. The fortified dairy product can be a homogenous powder having a pH level ranging from about pH 4.5 to about pH 7.0.

### BACKGROUND OF THE INVENTION

### 1. Field of the Invention

The method relates to producing a fortified dairy product, and particularly, to a method of producing a fortified dairy powder from fruit juice and camel milk.

### 2. Description of the Related Art

Recent developments in the global food industry have focused on an increased awareness of health and wellbeing. Consumers have a growing awareness and understanding that digestive health is particularly important and may play a role in allergies and intolerances that represent growing health concerns, particularly in children.

It is common for children to experience difficulty meeting the recommended dairy intake, which may lead to vitamin deficiencies. Flavored milks can assist in meeting these requirements; however, high amounts of sugar are generally added to low-fat and fat-free dairy products.

Camel milk is considered more nutritious than cow's milk. It contains lower fat and lactose levels, paired with higher levels of vitamins, minerals, and immunoglobulins. However, camel milk is highly perishable, which is especially problematic in hot climates. Thus, commercial camel milk production requires a comprehensive management system to produce, process, and sell the milk under active temperature control.

Thus, a method of making an acidified, fortified, dried camel milk powder including the beneficial aspects without the addition of further added sugars is desired.

### SUMMARY OF THE INVENTION

The method of producing a fortified dairy product includes concentrating fresh fruit juice and camel milk to provide a concentrated camel milk and a concentrated fruit juice. The concentrated camel milk and the concentrated fruit juice may be heated and blended to produce a homogenous mixture. The homogenous mixture may then be spray dried to produce a powdered, fortified dairy product. The ratio of fruit juice to camel milk may be adjusted in order to control the resulting pH of the fortified dairy product.

These and other features of the present invention will become readily apparent upon further review of the following specification.

### DETAILED DESCRIPTION OF THE PREFERRED EMBODIMENTS

A method of making a fortified dairy product includes concentrating an amount of fruit juice and an amount of camel milk to obtain an amount of concentrated camel milk and an amount of concentrated fruit juice. The concentrated camel milk and the concentrated fruit juice can be heated and blended to produce a mixture. The mixture can then be spray dried to produce the fortified dairy product. The fortified dairy product can be a homogenous powder having a pH level ranging from about pH 4.5 to about pH 7.0.

The camel milk can be any type of camel milk, including for example, whole camel milk, skimmed camel milk, semi-skimmed camel milk, and reconstituted camel milk. The fortified dairy product can have a longer shelf life than the camel milk. The fortified dairy product can include A2 β-casein, whey protein, and other components of camel milk.

The fruit juice is preferably fresh fruit juice. The juice can include one or more of any known fruit, including, for example, grape juice and pomegranate juice.

The steps of concentrating and spray drying can be optimized to avoid damaging vitamins, pigments, or other thermally sensitive desirable substances.

The concentration of the fruit juice and the camel milk can be performed by vacuum evaporation at a temperature between about 40 degrees Celsius and about 50 degrees Celsius. The vacuum evaporation can be performed using a Vacuum Rising Film Evaporator. In the alternative, concentration of the fruit juice may be performed by membrane filtration. The concentration can be allowed to proceed for a sufficient time to obtain a concentrate with a maximum concentration of about 45%.

The concentrated juice and concentrated camel milk can be heated to a temperature of about 40 degrees Celsius to about 50 degrees Celsius and blended to uniformity. The blending may be performed using an agitation vessel.

The blending step can further include titrating the ratio of concentrated juice to concentrated camel milk in order to adjust the pH of the final mixture. The titration can be performed to maintain a pH between about 4.50 and about 7.00. In one embodiment, the pH is maintained above 4.6. The ratio of concentrated fruit juice to concentrated camel milk can be adjusted in order to control acidification. Table 1 demonstrates the pH of different ratios of concentrated grape juice mixed with concentrated camel milk.

TABLE 1
Grape Juice Concentrate pH Titration

| % Concentrated Juice - % Concentrated Camel Milk | pH |
|---|---|
| 0-100 | 6.70 |
| 10-90 | 6.16 |
| 20-80 | 5.67 |
| 30-70 | 5.16 |
| 40-60 | 4.75 |
| 50-50 | 4.64 |

Table 2 demonstrates the pH of different ratios of concentrated pomegranate juice (35% w/w) and concentrated camel milk (20% w/w).

TABLE 2
Pomegranate Juice Concentrate pH Titration

| % Concentrated Juice - % Concentrated Camel Milk | Ph |
|---|---|
| 0-100 | 6.70 |
| 10-90 | 6.38 |
| 20-80 | 6.16 |
| 30-70 | 5.56 |
| 40-60 | 4.97 |
| 50-50 | 4.61 |

The blended mixture may be spray dried at a low temperature for a short time. For example, the spray drying can be performed at about 130 degrees Celsius to about 150 degrees Celsius for about two seconds to about ten seconds. The spray drying can be performed at a flow rate of about 4 liters per hour to about 5 liters per hour. A preferred temperature of the spray dryer is about 140 degrees Celsius.

### EXAMPLE 1

### Production of Fortified Dairy Product

Whole camel milk was concentrated using a vacuum rising film evaporator (40° C. to 50° C.) to obtain a concentrate with a maximum concentration of about 45%. Fresh fruit juices including at least one of grape and pomegranate juice was concentrated by membrane filtration. The concentrated camel's milk and the concentrated fruit juice were heated and then blended to uniformity in an agitated vessel. The blended mixture was dried using a pilot spray dryer to provide a homogenous, powdered fortified dairy product. The inlet temperature of the spray dryer was in the range of 130° C. to 150° C. (for few seconds) to preserve the vitamins and heat sensitive substances. The optimal temperature of the spray dryer was 140° C.

### EXAMPLE 2

### Physical and Chemical Properties of the Fortified Dairy Product

Physical, chemical, and nutritional properties of the powdered fortified dairy product were tested. Tables 3 and 4 recite the physical and chemical properties of the powdered fortified dairy product, including powder flowability (angle of repose) and mean diameter of the spray-dried particles. Increasing the juice content led to increased mean diameter of the spray dried particles, which ranged from about 30 μm to about 50 μm.

TABLE 3
Physical Properties of the Spray-Dried Powder

| Powder(% CM- | Angle | Bulk | Ins. | Water |
|---|---|---|---|---|
| % PGJ) | of Repose | Density | Index | Activity |
| 90-10 | 43.02 ± | 0.34 ± | 0.66 ± | 0.30 ± |
| | 0.42^{e} | 0.15^{ef} | 0.03^{ab} | 0.08^{de} |
| 80-20 | 46.75 ± | 0.37 ± | 0.78 ± | 0.28 ± |
| | 0.75^{f} | 0.01^{e} | 0.05^{b} | 0.00^{e} |
| 70-30 | 34.82 ± | 0.47 ± | 0.84 ± | 0.29 ± |
| | 0.00^{c} | 0.00^{cde} | 0.09^{b} | 0.00^{cde} |
| 60-40 | 33.69 ± | 0.45 ± | 6.51 ± | 0.25 ± |
| | 0.00^{bc} | 0.00^{b} | 0.24^{c} | 0.00^{bcd} |
| 50-50 | 40.18 ± | 0.399 ± | 7.09 ± | 0.19 ± |
| | 0.64^{d} | 0.00^{ab} | 0.33^{d} | 0.00^{ab} |

CM: Camel Milk,
PJ: Pomegranate Juice

TABLE 4
Chemical Properties of the Spray-Dried Powder

| Powder (% CM- | | | | % Titratable |
|---|---|---|---|---|
| % PGJ) | % M.C. | % Protein | % Ash | Acidity |
| 90-10 | 3.41 ± | 24.24 ± | 7.0 ± | 0.79 ± |
| | 0.55^{bcd} | 0.02^{e} | 0.03^{d} | 0.017^{b} |
| 80-20 | 4.49 ± | 23.19 ± | 6.62 ± | 0.85 ± |
| | 0.48^{d} | 0.15^{e} | 0.02^{cd} | 0.015^{b} |
| 70-30 | 4.44 ± | 21.17 ± | 5.90 ± | 1.18 ± |
| | 0.52^{d} | 0.07^{d} | 0.01^{bc} | 0.02^{g} |
| 60-40 | 2.74 ± | 14.33 ± | 5.51 ± | 1.08 ± |
| | 0.38^{ab} | 0.23^{b} | 1.15^{b} | 0.00^{d} |
| 50-50 | 4.06 ± | 12.34 ± | 3.36 ± | 1.30 ± |
| | 0.19^{cd} | 1.48^{a} | 0.01^{a} | 0.04^{h} |

CM: Camel Milk,
PJ: Pomegranate Juice

In addition to physical and chemical properties, the mineral composition of the powdered fortified dairy product using about 70% concentrated camel milk and about 30% concentrated pomegranate juice was tested (Table 5).

TABLE 5
Concentration of Minerals in ppm

| | Fe | K | Mg | Mn | Mo | Na | P | S | Zn |
|---|---|---|---|---|---|---|---|---|---|
| 6715 | 12 | 8927 | 516 | 0.68 | 0.81 | 4418 | 5425 | 2037 | 26 |

It is to be understood that the present invention is not limited to the embodiments described above, but encompasses any and all embodiments within the scope of the following claims.

We claim:

1. A method of producing a fortified dairy product, comprising the steps of:
concentrating fruit juice to provide concentrated fruit juice;
concentrating camel milk to provide concentrated camel milk;
heating the concentrated fruit juice to provide a heated fruit juice concentrate;
heating the concentrated camel milk to provide a heated camel milk concentrate;
blending the heated fruit juice concentrate with the heated camel's milk concentrate to produce a homogenous mixture; and
spray drying the homogenous mixture to provide the fortified dairy product.

2. The method of producing a fortified dairy product according to claim 1, wherein the fortified dairy product has a pH ranging from about pH 4.5 to about pH 7.0.

3. The method of producing a fortified dairy product according to claim 1, wherein the spray drying is performed at a temperature of about 130 degrees Celsius to about 150 degrees Celsius.

4. The method of producing a fortified dairy product according to claim 3, wherein the spray drying is performed at about 140 degrees Celsius.

5. The method of producing a fortified dairy product according to claim 1, wherein the spray drying is performed at a flow rate of about 4 liters per hour to about 5 liters per hour.

6. The method of producing a fortified dairy product according to claim 1, wherein the blending step further comprises titrating between about 0% by volume and about 50% by volume concentrated fruit juice into about 100% by volume to about 50% by volume concentrated camel's milk.

7. The method of producing a fortified dairy product according to claim 6, wherein the fruit juice comprise at least one of pomegranate juice and grape juice.

8. The method of producing a fortified dairy product according to claim 7, wherein the fruit juice is pomegranate juice.

9. The method of producing a fortified dairy product according to claim 8, wherein the blending step further comprises titrating about 30% by volume fruit juice concentrate into about 70% by volume concentrated camel's milk.

10. The method of producing a fortified dairy product according to claim 1, wherein the concentration steps are accomplished by vacuum evaporation.

11. The method of producing a fortified dairy product according to claim 10, wherein the vacuum evaporation is performed at a temperature ranging from about 40 degrees Celsius to about 50 degrees Celsius.

12. The method of producing a fortified dairy product according to claim 1, wherein the camel's milk is selected from the group consisting of whole camel milk, skimmed camel milk, semi-skimmed camel milk, and reconstituted camel milk.

13. A fortified dairy product produced by a method comprising:
concentrating fruit juice to provide concentrated fruit juice;
concentrating camel milk to provide concentrated camel milk;
heating the concentrated fruit juice to provide a heated fruit juice concentrate;
heating the concentrated camel milk to provide a heated camel milk concentrate;
blending the heated fruit juice concentrate with the heated camel milk concentrate to produce a homogenous mixture, the blending including titrating about 0% to about 50% concentrated fruit juice into about 100% to about 50% concentrated camel milk; and
spray drying the homogenous mixture to provide the fortified dairy product.

14. The fortified dairy product according to claim 13, wherein the fruit juice comprises at least one of pomegranate juice and grape juice.

15. The fortified dairy product according to claim 13, wherein the camel milk comprises at least one of whole camel milk, skimmed camel milk, semi-skimmed camel milk, and reconstituted camel milk.

16. The fortified dairy product according to claim 13, wherein the fortified dairy product has a pH ranging from about pH 4.5 to about pH 7.0.

17. The fortified dairy product according to claim 13, wherein the fortified dairy product has a pH above pH 4.6.
